(19) United States
(12) Patent Application Publication
(10) Pub. No.: US 2016/0267457 A1
(43) Pub. Date: Sep. 15, 2016

(54) PAYMENT SYSTEM FOR ENABLING TRANSACTIONS USING PREFERRED PAYMENT METHODS

(71) Applicant: Plastiq Inc., San Francisco, CA (US)

(72) Inventor: Daniel J. Choi, San Francisco, CA (US)

(21) Appl. No.: 15/068,509

(22) Filed: Mar. 11, 2016

Related U.S. Application Data
(60) Provisional application No. 62/133,443, filed on Mar. 15, 2015.

(51) Int. Cl. G06Q 20/22; G06Q 20/24; G06Q 20/40

(52) U.S. Cl. CPC G06Q 20/227; G06Q 20/409; G06Q 20/24

(57) ABSTRACT

A system and method to connect disparate payment systems is provided. Multiple concentric (i.e., tail-recursive) payment authorizations, initiated via a single, contextually viable payment system and involving as many real-time processing “jumps” as necessary to result in a payment submitted on a separate, desired payment system may be employed, enabling a consumer's preferred payment method to be used when an alternate payment method is presented to a merchant.

### CROSS-REFERENCE TO RELATED APPLICATIONS

The present application claims the benefit of U.S. Provisional Patent Application No. 62/133,443, filed Mar. 15, 2015, the disclosure of which is hereby incorporated by reference herein in its entirety.

### TECHNICAL FIELD

Embodiments of the invention relate generally to payment processing systems and, more specifically, to a payment processing system enabling real-time payment transactions using a preferred payment method under the guise of an alternate payment method.

### BACKGROUND

Viable means of payment have historically been defined by the merchants who provide goods or services in exchange for said payment. In primitive barter systems, merchants defined what they would be willing to receive as compensation for their goods or services. This arrangement naturally resulted in inefficiencies, as a consumer's ability to purchase from a merchant relied upon offering precisely what the merchant valued. Eventually, fiat currency arose to address this inefficiency, abstracting value to inherently value-less “cash” to facilitate the trade of goods and services.

Fiat currency worked well, and the march toward even more efficient means of commerce continued with the growth of centralized currency backed by sovereign governments, followed by banks as a means for storing and accessing liquidity, and payment systems which arose to facilitate the actual transfer of value away from the point of sale. Payment systems are, however, inherently discrete, in the sense that commerce conducted on a payment system must rely on all parties (i.e., consumer, merchant, etc.) to be connected to the system. If a merchant does not accept payments via a given payment system, the consumer has no option to pay via that payment system.

Accordingly, there is a desire to provide a mechanism by which an alternate payment method, considered viable to a merchant, may be employed by a consumer to conduct a transaction as if the consumer employed his or her preferred payment method.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIGS. 1A and 1B are block diagrams illustrating an exemplary system in which embodiments of the present invention may operate.

FIG. 2 is a flow diagram illustrating a method for associating a preferred payment method (PPM) with an alternate payment method (APM) in accordance with an embodiment of the invention.

FIG. 3 is a flow diagram illustrating a method for conducting a transaction using the PPM in accordance with an embodiment of the invention.

FIG. 4 illustrates a diagrammatic representation of a machine in the exemplary form of a computer system configured to perform one or more of the operations described herein.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the description that follows, it is appreciated that throughout the description, discussions utilizing terms such as “receiving”, “collecting”, “associating”, “determining”, “requesting”, “transmitting”, “identifying”, “issuing”, “transferring”, “generating”, “authorizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description that follows. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

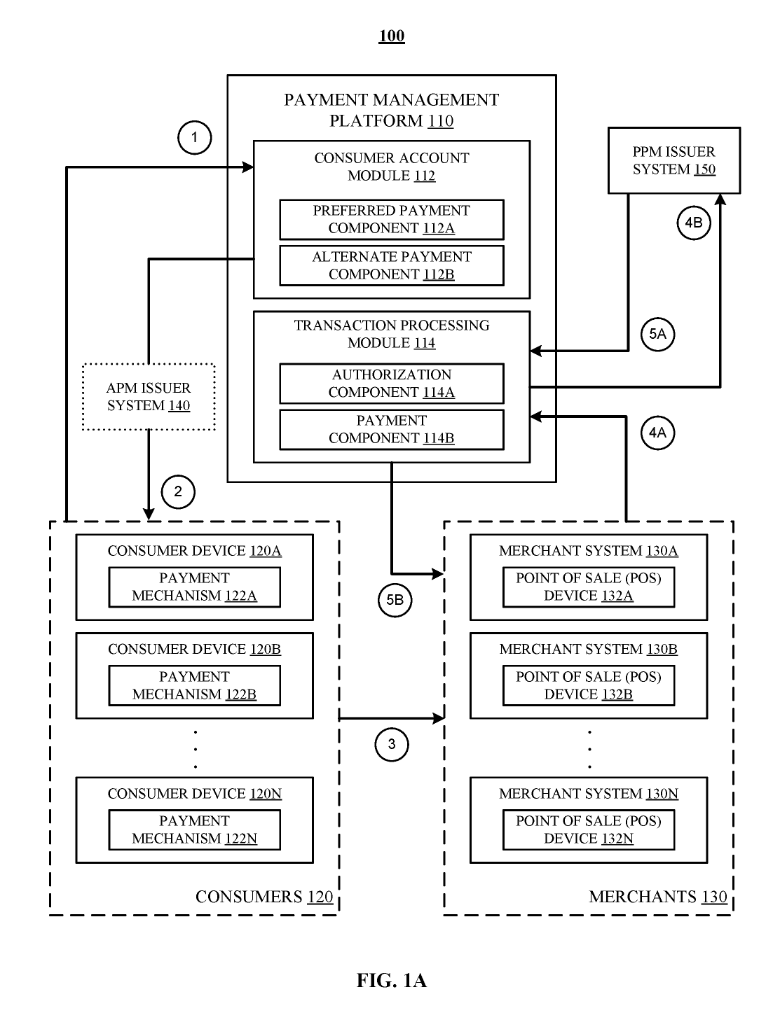

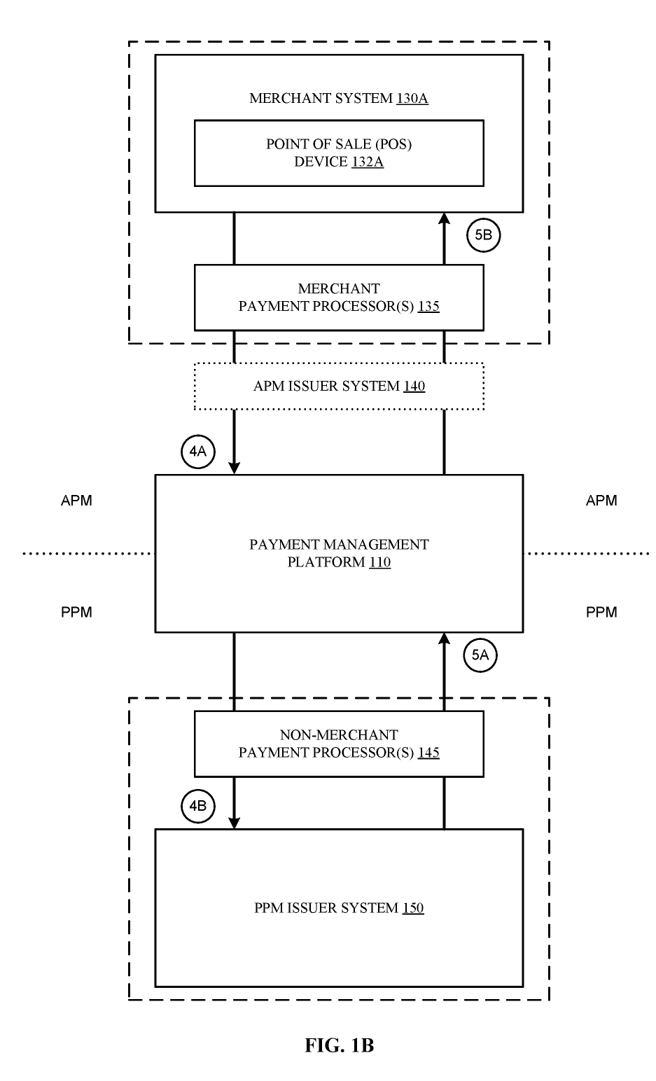

FIG. 1A is a block diagram illustrating an exemplary system 100 in which embodiments of the present invention may operate. Referring to FIG. 1A, system 100 may be comprised of a computer-enabled payment management platform 110, a plurality of consumer devices 120A-120N, collectively referred to herein as consumers 120, and a plurality of merchant systems 130A-130N, collectively referred to herein as merchants 130. Payment management platform 110, consumers 120 and merchants 130 may be communicatively coupled directly or indirectly (e.g., through a third party system) via a communication network. The communication network (not shown) may be a private network (e.g., a local area network (LAN), wide area network (WAN), intranet, etc.), a public network (e.g., the Internet), a cellular network or any combination thereof.

Payment management platform 110 may be comprised of one or more modules for managing various tasks, and each module may be comprised of one or more components responsible for enabling the execution of one or more tasks. For example, in one embodiment, payment management platform 110 may be comprised of a consumer account module 112 and a transaction processing module 114. Consumer account module 112 and transaction processing module 114 may be communicatively coupled to each other, as well as to one or more external systems, for exchanging relevant consumer and transaction data. In particular, transaction processing module 114, in response to receiving data relating to a transaction where a consumer's alternate payment method is used, may retrieve data associated with the consumer's preferred payment method from consumer account module 112.

A preferred payment method (PPM) is a payment method that a consumer would prefer to use to pay a merchant in a given context, but which may not be accepted by the merchant. An alternate payment method (APM) is a contextually viable payment method, wherein contextually viable, as used herein, refers to a payment method that is accepted by a merchant in a given context/situation. For example, when paying at a gas station, contextually viable payment methods may include cash or credit/debit card, but not checks. As another example, when paying at a restaurant, contextually viable payment methods may include select credit cards, but not others.

Consumer account module 112 may be configured to manage aspects of consumer pay mechanisms as they relate to PPMs and APMs including, but not limited to, credit cards, debit cards, prepaid cards, gift cards, loyalty cards, digital and cryptocurrencies, fiat currencies, securities and commodities, materials of inherent value, physical goods or services, or any combination thereof. A PPM and an APM associated with a consumer account may be managed, respectively, by a preferred payment component 112A and an alternate payment component 112B of consumer account module 112. Preferred payment component 112A may be configured to regulate storage of one or more consumer PPMs, provide access to data in order to allow transaction processing module 114 to securely integrate with payment processors for PPMs, assess context-driven transaction criteria for selection and use of PPMs, and transmit data as needed to third party systems associated with PPMs (e.g., issuing bank of a preferred payment card). Alternate payment component 112B may be configured to regulate storage of one or more consumer APMs, provide access to data related to associations between a consumer APM and one or more of the consumer's PPMs, and transmit data as needed to third party systems associated with the APM (e.g., issuing bank of an alternate payment card).

Transaction processing module 114 may be configured to manage aspects of merchant transactions as they relate to consumer pay mechanisms involving PPMs and APMs. Merchant transactions may be managed, for example, by an authorization component 114A and a payment component 114B of transaction processing module 114. Authorization component 114A may be configured to regulate transaction authorization requests by receiving and transmitting relevant transaction data, as well as communicate with consumer account module 112 as needed to retrieve relevant consumer data for processing transaction authorization requests. Payment component 114B may be configured to regulate responses to payment authorization requests (e.g., relay of approval/denial of an authorization request to a merchant system), assess any fees due by payment management platform 110, and process settlement of payments due. In an alternate embodiment, transaction processing module 114 may be independent of payment management platform 110 and reside on one or more external systems (e.g., a partner system, a card issuer system, etc.) communicatively coupled to payment management platform 110.

Each of consumer devices 120A-120N may be comprised, respectively, of payment mechanisms 122A-122N. Each of payment mechanisms 122A-122N may correspond to a consumer's APM, wherein an established relationship between the consumer's APM and the consumer's PPM may be managed by consumer account module 112 of payment management platform 110. The term “consumer device” as used herein may refer to an electronic device (e.g., a mobile pay application residing on mobile phone, watch, etc.) or a non-electronic device (e.g., a credit card) enabling a payment mechanism corresponding to an APM.

Each of merchant systems 130A-130N may be comprised, respectively, of point of sale (PoS) devices 132A-132N. Each of payment mechanisms 132A-132N may be configured to conduct a transaction using a consumer's presented payment mechanism, wherein the presented payment mechanism represents an APM considered contextually viable for purposes of conducting the desired transaction between the consumer and the merchant.

Brokering of communications to and from payment management platform 110 may be enabled by a plurality of communication channels, as illustrated in FIGS. 1A and 1B. Referring to FIG. 1A, communication between payment management platform 110 and consumers 120 may be enabled via communication channels 1 and 2. Consumer-related information, including a consumer's preferred payment methods, may be communicated to consumer account module 112 of payment management platform 110, for example, via communication channel 1. While information relating to issuance of an APM, including associated relationships between the APM and a stored PPM, may be communicated to consumers from consumer account module 112 of payment management platform 110, for example, via communication channel 2. In an alternate embodiment, consumer account module 112 of payment management platform 110 may relay a request for an APM to an APM issuer system 140 (e.g., a partner issuer of APMs) to issue the APM to a consumer. Upon issuance of the APM, consumers 120 may communicate with any one of desired merchants 130, for example, via communication channel 3.

Consumer transactions may be communicated by merchants 300 to payment management platform 110, for example, via communication channel 4A. Communication channel 4A may provide for direct or indirect communication with transaction processing module 114 of payment management platform 110. For example, when an APM is used at POS device 132A associated with merchant system 130A, a merchant payment processor 135, as illustrated in FIG. 1B, may transmit a transaction authorization request to transaction processing module 114 of payment management platform 110. In an alternate embodiment, as previously described, transaction authorization requests transmitted by a merchant system may be received by an intermediary system before being relayed to transaction processing module 114 of payment management platform 110 for further processing. For example, a transaction authorization request may be received at an APM issuer system 140 from merchant payment processor 135, as illustrated in FIG. 1B, wherein APM issuer system 140 may represent the issuer of the APM (e.g., a credit card) used by the consumer.

When a transaction authorization request associated with an APM is received at transaction processing module 114 of payment management platform 110, whether directly or indirectly from a merchant system, transaction processing module 114 of payment management platform 110 may further transmit details of the transaction authorization request to a non-merchant payment processor 145 of a PPM issuer system 150, for example, via communication channel 4B. PPM issuer system 150 may represent the issuer of the PPM (e.g., a credit card) selected based on the APM used by the consumer, wherein the consumer desired PPM selected may be based in part on details associated with the transaction. Accordingly, concentric transaction authorization requests may be communicated via channels 4A and 4B before a response to the transaction authorization request may be returned to transaction processing module 114 of payment management platform 110, for example via channel 5A, and then to merchants 130, for example via channel 5B.

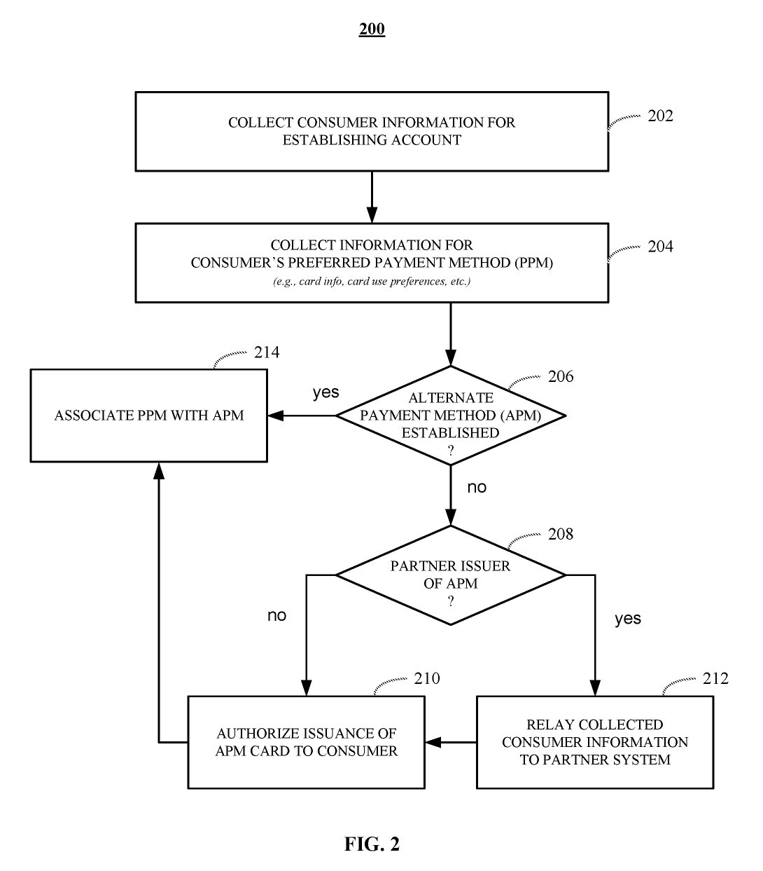

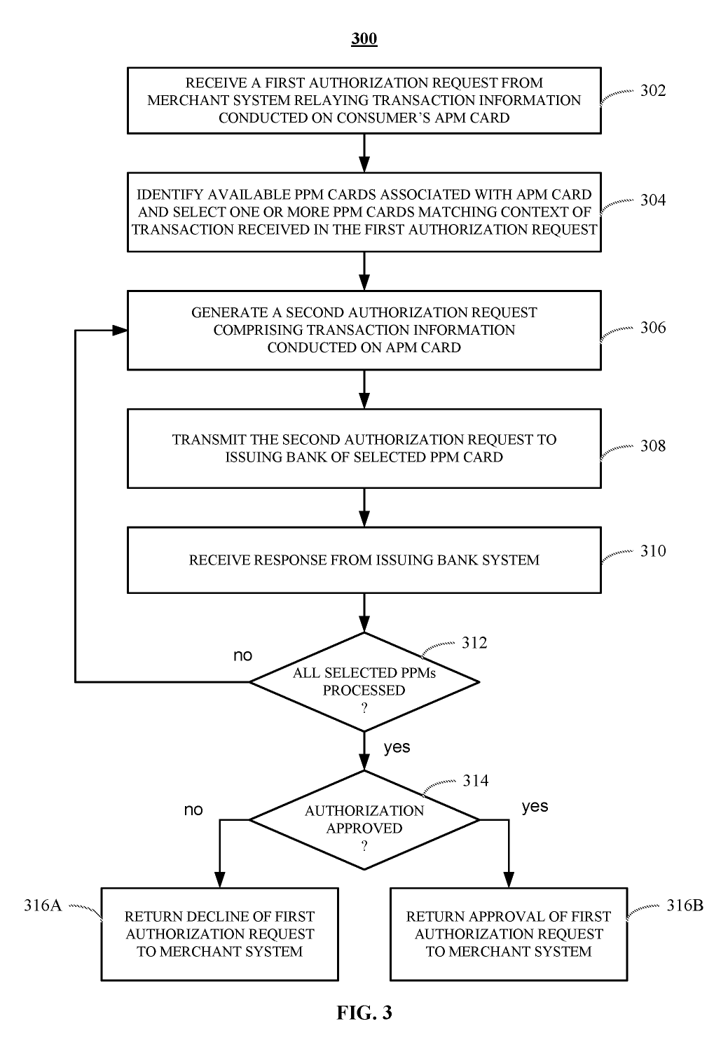

While modules of payment management platform 110 are shown as being co-located on a single platform, those skilled in the art will appreciate from the foregoing description that one or more of the modules may be located elsewhere and communicatively coupled with payment management platform 110, and that payment management platform 110 is not limited to the modules shown, which are provided merely for purposes of illustrating an exemplary embodiment of the invention. Those skilled in the art will appreciate that payment management platform 110 may be configured with more or less modules to conduct the methods described herein with reference to FIG. 2 and FIG. 3.

As illustrated in FIG. 2 and FIG. 3, each of corresponding methods 200 and 300 may be performed by processing logic comprising hardware (e.g., circuitry, dedicated logic, programmable logic, microcode, etc.), software (such as instructions run on a processing device), or a combination thereof. In one embodiment, methods 200 and 300 may be performed by one or more processing components associated, respectively, with modules 112 and 114 of payment management platform 110.

FIG. 2 is a flow diagram illustrating a method 200 for associating a preferred payment method (PPM) with an alternate payment method (APM) in accordance with an embodiment of the invention. Referring to FIG. 2, method 200 may be initiated by collecting, at step 202, consumer information for establishing an account. Consumer information collected may include, but is certainly not limited to, credit history, credit details, demographic information, contact information, interests, affiliations, memberships, preferences, methods of authentication (e.g., password, biometrics, etc.) or any combination thereof.

When a consumer account is established, information may be collected, at step 204, for the consumer's PPM (e.g., preferred credit card and related information, credit card use preferences, etc.). In one embodiment, a consumer may identify more than one PPM for use with different types of transactions. In that case, information may be collected for each PPM and stored, for example, by preferred payment component 112A of consumer account module 112. Transaction types may be based on the transaction amount, category of goods involved, merchant, geography, currency, time of transaction or any other available context-driven criteria elected by the consumer for selecting a PPM to be used in connection with a transaction. In another embodiment, more than one PPM may be configured with the same criteria matching a transaction type to trigger the use of multiple PPMs (e.g., to split charges across multiple PPMs).

When a PPM is received for a consumer account, a determination may be made, at step 206, to determine whether an APM has been previously established for the consumer account. The determination may be made, for example, by alternate payment component 112B of consumer account module 112. If an APM has been previously established for the consumer account, then the PPM may be associated, at step 214, with the stored APM in the consumer account. If an APM has yet to be established for the consumer account, then a further determination may be made, at step 208, whether issuance of an APM is handled by a partner. If issuance of an APM is not handled by a partner, then authorization for issuance of an APM card is processed, at step 210, to provide the consumer with an APM and the PPM is then associated, at step 214, with the APM provided to the consumer. If issuance of an APM is handled by a partner (e.g., via APM issuer system 140), then collected consumer information may be relayed, at step 212, to the partner in order to authorize, at step 210, issuance of an APM card. The consumer's PPM may then be associated, at step 214, with the APM provided to the consumer by the partner.

FIG. 3 is a flow diagram illustrating a method 300 for conducting a transaction using the PPM in accordance with an embodiment of the invention. For purposes of illustration, and not by way of limitation, method 300 is described with reference to a credit card payment mechanism for the consumer's APM and PPM.

Referring to FIG. 3, method 300 may be initiated by receiving, at step 302, a first authorization request from a merchant system, the first authorization request relaying transaction information conducted on a consumer's APM card. Upon receiving the first authorization request, available PPMs associated with the consumer's APM card may be identified, at step 304, in order to select one or more PPM cards to be used for the consumer transaction with the merchant.

In one embodiment, selection of the PPM card(s) may be based in part on details associated with the transaction that correspond to the context-driven criteria associated with a stored PPM card. For example, if the transaction between the consumer and merchant corresponds to a value exceeding $500 and the consumer has identified a particular PPM card to be used when this criteria is met, then that particular PPM card may be selected automatically. It should be noted that preferred payment component 112A of consumer account module 112 may be tasked with managing available criteria associated with each PPM stored in a consumer's account so as to avoid conflicting selection of a PPM. In another embodiment, selection of a PPM may be achieved by contacting the consumer in real-time to confirm or change a selected PPM, as well as to add an additional PPM to a selected PPM (e.g., to split charges across multiple PPMs).

Upon selection, at step 304, of one or more PPM cards associated with the APM card used in conducting a transaction with the merchant, at least one second concentric authorization request may be generated, at step 306, comprising transaction information conducted on the APM card and transmitted, at step 308, to the issuing bank of the selected PPM card. A determination may be made, at step 312, whether all selected PPMs have been processed. Processing a plurality of selected PPMs (i.e., executing multiple instances of steps 306-310) may be conducted in an ordered or concurrent manner. A further determination may be made, at step 314, whether the authorization is approved or declined and a corresponding response to the first authorization request may be returned, at step 316A or 316B, to the merchant system. Whether authorization is approved or declined, where multiple PPMs are selected for use, may be based on whether all the PPMs selected for use have been processed successfully. When approved, the APM card presented to the merchant system results in a transfer of value via the PPM card.

It should be noted that the sequence or number of operations described in conjunction with methods 200 and 300 may be different from that illustrated, respectively, in corresponding FIGS. 2 and 3. For example, referring to FIG. 3, method 300 may include one or more additional steps between steps 302 and 306, steps 314 and 316A/B, or both directed at processing of an authorization request not involving external systems. The steps illustrated in methods 200 and 300 are provided for purposes of illustrating embodiments of the invention and are in no way intended to be limiting in scope.

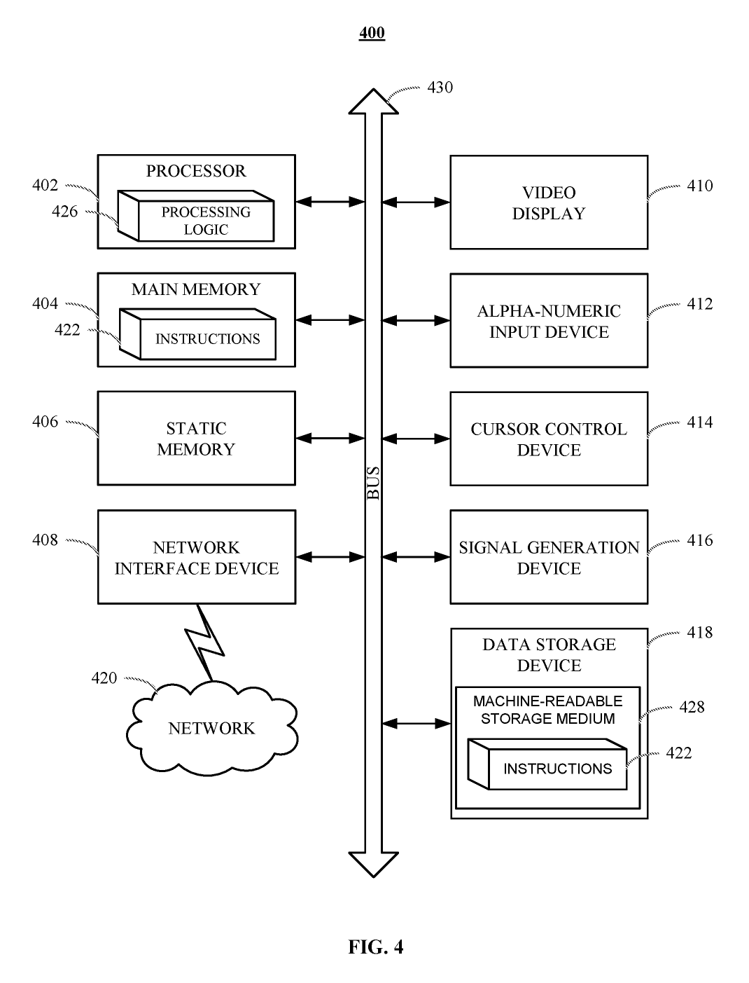

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 may be comprised of a processor 402, a main memory 404 (e.g., read-only memory (ROM), flash memory, dynamic random access memory (DRAM) (such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processor 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 402 may also be one or more special-purpose processing devices such as an application specific integrated circuit (ASIC), a field programmable gate array (FPGA), a digital signal processor (DSP), network processor, or the like. Processor 402 is configured to execute processing logic 426 for performing the operations and steps discussed herein.

Computer system 400 may further include a network interface device 408. Computer system 400 also may include a video display unit 410 (e.g., a liquid crystal display (LCD) or a cathode ray tube (CRT)), an alphanumeric input device 412 (e.g., a keyboard), a cursor control device 415 (e.g., a mouse), and a signal generation device 416 (e.g., a speaker).

Data storage device 418 may include a machine-readable storage medium (or more specifically a computer-readable storage medium) 428 having one or more sets of instructions (e.g., software 422) embodying any one or more of the methodologies of functions described herein. For example, software 422 may store instructions to conduct a rewards program. Software 422 may also reside, completely or at least partially, within main memory 404 and/or within processor 402 during execution thereof by computer system 400; main memory 404 and processor 402 also constituting machine-readable storage media. Software 422 may further be transmitted or received over a network 420 via network interface device 408.

Machine-readable storage medium 428 may also be used to store instructions to conduct a rewards program. While machine-readable storage medium 428 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment described and shown by way of illustration is in no way intended to be considered limiting. Therefore, references to details of various embodiments are not intended to limit the scope of the claims, which in themselves recite only those features regarded as the invention.

What is claimed is:

1. A computer-implemented method, said method comprising:
receiving, at a programmed computer, a first authorization request from a merchant payment system corresponding to a transaction, said first authorization request identifying a payment mechanism corresponding to an alternate payment method for a consumer, and said first authorization request relaying information for said transaction conducted via said alternate payment method;
identifying, using said programmed computer, a preferred payment method associated with said alternate payment method for said consumer;
transmitting, using said programmed computer, a second authorization request to a non-merchant payment system, said non-merchant payment system associated with said preferred payment method;
receiving, at said programmed computer, a response to said second authorization request from said non-merchant payment system associated with said preferred payment method;
transmitting, using said programmed computer, said response to said first authorization request; and
transferring, using said programmed computer, a transaction value identified in said first authorization request initiated using said alternate payment method to said preferred payment method.

2. The computer-implemented method of claim 1, further comprising:
receiving, at said programmed computer, said first authorization request from said merchant system through a non-merchant payment system associated with said alternate payment method; and
transmitting, using said programmed computer, said response to said first authorization request to said non-merchant payment system associated with said alternate payment method, said non-merchant payment system associated with said alternate payment method being communicatively coupled to said merchant system.

3. The computer-implemented method of claim 1, further comprising recursively transmitting said second authorization request and receiving said response to said second authorization request when more than one of said preferred payment method is identified for use in said transaction conducted via said alternate payment method.

4. The computer-implemented method of claim 1, wherein said payment mechanism corresponding to said alternate payment method is a card for conducting a financial transaction, said card associated with at least one preferred payment method.

5. The computer-implemented method of claim 1, wherein said preferred payment method is a preferred credit card of said consumer.

6. The computer-implemented method of claim 1, wherein said alternate payment method is associated with a plurality of preferred payment methods.

7. The computer-implemented method of claim 6, wherein one of said plurality of preferred payment methods is selected for use in said transaction based at least in part on details associated with said transaction matching context-driven criteria associated with a preferred payment method.

8. The computer-implemented method of claim 6, wherein context-driven criteria associated with said preferred payment method is a value-based transaction criteria.

9. The computer-implemented method of claim 6, wherein context-driven criteria associated with said preferred payment method is a categorical-based transaction criteria.

10. The computer-implemented method of claim 6, wherein context-driven criteria associated with said preferred payment method is a merchant-based transaction criteria.

11. The computer-implemented method of claim 6, wherein context-driven criteria associated with said preferred payment method is a geographical-based transaction criteria.

12. The computer-implemented method of claim 6, wherein context-driven criteria associated with said preferred payment method is a time-based transaction criteria.

13. A computer system, comprising:
a memory; and
a processing device communicatively coupled to said memory, said processing device configured to:
receive a first authorization request from a merchant payment system corresponding to a transaction, said first authorization request identifying a payment mechanism corresponding to an alternate payment method for a consumer, and said first authorization request relaying information for said transaction conducted via said alternate payment method;
identify a preferred payment method associated with said alternate payment method for said consumer;
transmit a second authorization request to a non-merchant payment system, said non-merchant payment system associated with said preferred payment method;
receive a response to said second authorization request from said non-merchant payment system associated with said preferred payment method;
transmit said response to said first authorization request; and
transfer a transaction value identified in said first authorization request initiated using said alternate payment method to said preferred payment method.

14. A non-transitory computer-readable storage medium programmed to include instructions that, when executed by a processing device, cause the processing device to perform a method, said method comprising:
receiving a first authorization request from a merchant payment system corresponding to a transaction, said first authorization request identifying a payment mechanism corresponding to an alternate payment method for a consumer, and said first authorization request relaying information for said transaction conducted via said alternate payment method;
identifying a preferred payment method associated with said alternate payment method for said consumer;
transmitting a second authorization request to a non-merchant payment system, said non-merchant payment system associated with said preferred payment method;
receiving a response to said second authorization request from said non-merchant payment system associated with said preferred payment method;
transmitting said response to said first authorization request; and
transferring a transaction value identified in said first authorization request initiated using said alternate payment method to said preferred payment method.
